(19) United States
(12) Patent Application Publication
(10) Pub. No.: US 2007/0187251 A1
(43) Pub. Date: Aug. 16, 2007

(54) VARIABLE GEOMETRY ELECTROPHORESIS CHIPS, MODULES AND SYSTEMS

(75) Inventor: Anthony John Ward, San Diego, CA (US)

Correspondence Address: BUCHANAN, INGERSOLL & ROONEY LLP, P.O. BOX 1404, ALEXANDRIA, VA, 22313-1404, US

(73) Assignee: Anthony John Ward, San Diego, CA (US)

(21) Appl. No.: 11/673,764

(22) Filed: Feb. 12, 2007

Related U.S. Application Data
(60) Provisional application No. 60/773,365, filed on Feb. 14, 2006.

(51) Int. Cl. G01N 27/00

(52) U.S. Cl. 204/601

(57) ABSTRACT

In general, the invention relates to the design and fabrication of electrophoresis chips, modules, arrays and systems suitable for use in methods associated with micro electrophoresis.

### CROSS REFERENCE TO RELATED APPLICATIONS

This application claims priority to U.S. Provisional Application Ser. No. 60/773,365 filed Feb. 14, 2006, the disclosure of which is incorporated herein by reference.

### TECHNICAL FIELD

This invention relates to electrophoresis chips, modules and systems. The invention further relates to methods of fabricating and using such chips, modules and systems.

### BACKGROUND

Electrophoresis is an important technique useful for separating various analytes including proteins and nucleic acids. Microchip electrophoresis platforms have a wide variety of useful applications, particularly in the field of laboratory on a chip and other applications where microfluidics are of importance. The use of a microchip electrophoresis platform significantly reduces the amount of sample and time required for analyte analysis. Currently available microchip electrophoresis platforms generally rely on the introduction of micro-fabricated channels enclosed within a substrate. Such channels provide the structures in which separation matrices are formed and reside during analyte separation.

The micro-machining and semiconductor processing technologies are applicable in the development of electrophoresis chips, modules and systems for separating trace amounts of sample with high resolution. For example, micro-machining technology can be used to produce channels and structures that regulate the liquid flow in such channels on an electrophoresis chip. Semiconductor processing technology can be used to produce micro-structures on suitable substrate surfaces by photolithography or etching.

Despite these advances in electrophoresis chip manufacturing, there exists a need for the rapid and reproducible manufacture of an electrophoresis chip that accommodates virtually any conformation of electrophoretic matrix (e.g., separation matrix) and does not require the use of channels to support or contain such a matrix.

### SUMMARY

Provided herein are electrophoresis chips, modules, arrays and systems, and methods of fabricating and using such devices. In one embodiment an electrophoresis chip is provided. The chip includes: a) a substrate having at least one surface suitable for supporting structures in and/or on the substrate; b) an electrophoretic pathway associated with the surface or readily accessible structure and configured to support the deposition of an electrophoretic matrix; c) a non-electrophoretic region associated with the surface and adjacent to the electrophoretic pathway, wherein the region does not support the deposition of an electrophoretic matrix; and d) an electrophoretic matrix associated with the electrophoretic pathway. The electrophoretic matrix is characterized as: 1) elevated in relation to, and structurally independent of, the adjacent region; and 2) spatially configured to support a flow path for the electrophoretic translocation of at least one analyte. In general the flow path includes a proximal end for analyte in flow and a distal end.

In one aspect the electrophoretic pathway includes hydrophilic material, the non-electrophoretic region includes hydrophobic material, and the electrophoretic matrix includes hydrophilic material. In another aspect the pathway includes hydrophobic material, the region includes hydrophilic material, and the electrophoretic matrix includes hydrophobic material. In some aspects the electrophoretic matrix is covalently associated with the electrophoretic pathway. In other aspects the electrophoresis chip includes electrodes operably associated with the electrophoresis matrix.

The configuration of the electrophoretic matrix associated with the electrophoresis chip includes linear, circular, coiled, curved, saw-toothed, or switchback, or any combination thereof. In some aspects, the configuration of the electrophoretic matrix includes two or more flow paths converging in to, or diverging from, a single flow path associated with either the proximal end or distal end of the flow path.

In another aspect a chip provided herein further includes a reservoir disposed to the proximal end of the flow path of the electrophoresis matrix. The reservoir can include a void region contained within the matrix. In addition, an electrophoresis chip provided herein optionally includes a stacking matrix flowably connected with the proximal end of the flow path of the electrophoresis matrix.

In yet another embodiment, an electrophoresis module that includes: a) an electrophoresis chip; b) a chamber; and c) electrodes detachably connected to the chip for applying a voltage across the electrophoresis matrix suitable for the electrophoretic translocation of at least one analyte through the electrophoretic matrix. In general the electrodes include a cathode operably associated with the proximal end of the electrophoresis matrix and an anode operably associated with the distal end of the electrophoresis matrix.

In another embodiment, a plurality of electrophoresis modules can be included in an electrophoresis array configuration.

In another embodiment, an electrophoresis module or array can be included in a system. The system includes: 1) a plurality of fluid communication ports located around a periphery of the module or array; 2) a radiation source associated with the module or each module of the array and configured to illuminate the electrophoresis matrix, wherein the radiation source is suitable for generating detectable representations of analytes; 3) a detector assembly configured to capture the representations associated with each electrophoresis matrix; and 4) a controller operably associated with the system and configured to synchronize the voltage input from a power source with the configuration of each electrophoresis matrix and electronically record and/or display the representations captured by the detector. In one aspect, the controller is further configured to synchronize representation detection by detector with the voltage input from a power source. In other aspects, the detector assembly includes a complementary metal oxide semiconductor (CMOS) imager, a charge coupled device (CCD) imager, a camera with photosensitive film, a photodiode, a Vidicon camera, or any combination thereof.

In another embodiment, an electrophoresis chip is provided. The chip includes: a) a substrate including at least one surface suitable for supporting structures in and/or on the substrate; b) a guide pathway associated with the surface and configured to direct the deposition of an electrophoretic matrix; c) a non-electrophoretic region associated with the surface and adjacent to the electrophoretic pathway, wherein the region does not support the deposition of an electrophoretic matrix; and d) an electrophoretic matrix associated with the guide pathway. The matrix is 1) confined to guide pathway and structurally independent of the guide pathway on at least one side; and 2) spatially configured to support a flow path for the electrophoretic translocation of at least one analyte. In general the flow path includes a proximal end for analyte in flow and a distal end. In one aspect, the guide pathway is a pair of ridges that facilitate the localization of the matrix.

The details of one or more embodiments of the disclosure are set forth in the accompanying drawings and the description below. Other features, objects, and advantages will be apparent from the description and drawings, and from the claims.

### BRIEF DESCRIPTION OF DRAWINGS

FIG. 1 depicts a hydrophilic gel matrix associated with a predetermined hydrophilic pathway.

FIG. 2 depicts a hydrophobic gel matrix associated with a predetermined hydrophobic pathway.

FIG. 3A depicts an exemplary configuration of an electrophoretic matrix including a reservoir.

FIG. 3B depicts an electrophoresis module including an electrophoresis chip.

FIG. 4 depicts an exemplary configuration of an electrophoretic matrix including a reservoir.

FIG. 5 depicts an exemplary configuration of an electrophoretic matrix including a reservoir.

FIG. 6 depicts a reservoir including a void space.

FIG. 7 depicts a converging matrix configuration.

FIG. 8 depicts a diverging matrix configuration.

FIG. 9 depicts a matrix configuration for resolution of analytes in two dimensions.

FIG. 10 depicts an exemplary electrophoresis module.

FIG. 11 depicts an exemplary electrophoresis array including multiple modules, each module housing a self-contained electrophoresis system.

FIG. 12 depicts a cross-section of two modules associated with an exemplary array.

FIG. 13 depicts an exemplary electrophoresis system.

Like reference symbols in the various drawings indicate like elements.

### DETAILED DESCRIPTION

Microfluidic systems have become increasingly popular tools in electronics, biotechnology, and the pharmaceutical and related industries where they provide numerous advantages, including significantly smaller reagent requirements, high speed of analysis and the possibility for automation [U.S. Pat. No. 6,251,343 and U.S. Pat. No. 6,379,974]. Examples of such microfluidic devices include electrophoresis chips, such as planar microcapillary electrophoresis chips disclosed in Manz et al (Trends in Anal. Chem. (1990), 10:144-149 and Adv. in Chromatog., (1993), 33:1-66). Such devices are also discussed in U.S. Pat. No. 4,908,112 and U.S. Pat. No. 6,309,602.

In microfluidic devices the transport and direction of materials, e.g., fluids, analytes and reagents within the micro-fabricated device, has generally been carried out by: (a) creating a pressure gradient; (b) the use of electric fields; (c) the use of acoustic energy. Electrophoresis chips generally utilize electric fields to translocate materials through a separation matrix, such as agarose or acrylamide. In order to fabricate microfluidic devices, the biotechnology and pharmaceutical industries have recently applied some of the same technologies that have proved effective in the electronics industry, such as photolithography, wet chemical etching, laser ablation, injection molding etc. As microfluidic systems become more complex, the ability to design and use them, including user handling and system interfacing of such devices, becomes more and more difficult.

With regard to microfluidic electrophoresis devices, it would be advantageous to provide improved methods for designing and manufacturing chips that incorporate mechanisms for accommodating flexible electrophoretic matrix configurations. Such chips are capable of being readily adapted to electrophoresis modules for separation or analytical tasks. A plurality of such modules can be assembled in an electrophoresis array configuration for rapid separation and detection of multiple analytes. An electrophoresis module or array can be included in a system suitable for modulating the activity of each module, detecting analytes present in a matrix, and recording the data generated from the detected analytes. Embodiments described below include electrophoresis chips, modules, arrays and systems. Methods of manufacturing and using such devices to detect analytes in a material are also provided.

The term “electrophoresis chip” typically refers to a precise, miniaturized device manufactured using a silicon chip, glass or polymer as substrate and integrating micro technologies in the fields of mechanico-electrical (MEMS), opto-electrical, chemistry, biochemistry, medical engineering and molecular biology. Electrophoresis chips may be used in medical testing, environmental testing, food testing, new drug development, basic research, military defense, and chemical synthesis. Electrophoresis chips for biomedical testing fabricated by MEMS process offers the advantages of high performance, low sample consumption, low energy consumption, small size, and low cost. The term “electrophoresis chip” refers to microfluidic BioMEMS devices specifically used for electrophoresis applications.

The term “BioMEMS” generally describes devices fabricated using MEMS techniques specifically applied towards biochemical applications. Such applications may include detection, sample preparation, purification, isolation etc. and are generally well know to those skilled in the art. One such technique that can be used in BioMEMS applications is that of “chip electrophoresis.” In general, electrophoresis is a process wherein an electrical field is applied across an electrophoretic matrix leading to the separation of constituents based on their mass/charge ratio.

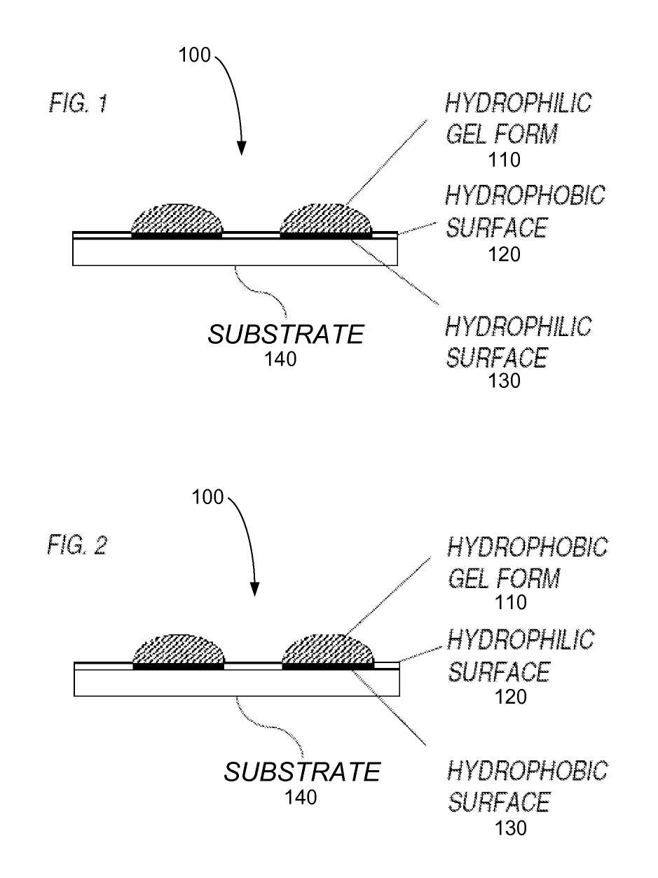

Accordingly, in one embodiment an electrophoresis chip is provided. Referring to FIG. 1 and FIG. 2, electrophoresis chip 100 is configured to include substrate 140 having at least one surface suitable for supporting structures in and/or on the substrate. While generally substantially planar, it is understood that the configuration of the surface can include, e.g. concave and/or convex features suitable for supporting structures. Structures include layers of deposited materials such as hydrophobic materials, hydrophilic materials, and matrices suitable for performing electrophoresis. It is understood that the term “structure” also includes features that are introduced in to the substrate by etching or micromachining. It is also understood that the substrate can include raised structures that provide additional surfaces for the deposition of e.g. a matrix. Electrophoretic pathway 130 is associated with the surface and configured to support the deposition of electrophoretic matrix 110. A non-electrophoretic region 120 associated with substrate 140 and adjacent to electrophoretic pathway 130. Non-electrophoretic region 120 does not support the deposition of electrophoretic matrix 110. Electrophoretic matrix 110 is elevated in relation to, and structurally independent of, non-electrophoretic region 120. Electrophoretic matrix 110 is spatially configured to support a flow path for the electrophoretic translocation of at least one analyte. In general the flow path includes a proximal end for analyte in flow and a distal end.

In other embodiments, a chip provided herein includes a “guide pathway” associated with the substrate and configured to confine the electrophoresis matrix in a predetermined pattern. The guide pathway can be, for example, a channel. However, it is understood that a guide pathway provided herein does not completely enclose the associated matrix. The matrix may conform to the geometry of the guide pathway. However, the matrix is structurally independent of the guide pathway on at least one side, distinguishing the present invention from other chips that utilize completely enclosed channels.

An electrophoresis chip provided herein can be used for detection of biochemically relevant analytes from a sample, such as a liquid sample. The incorporation of such a chip in a module, array and/or system provides for the regulation of analyte translocation through a suitable matrix with the aim of detecting and analyzing data generated during and subsequent to a separation event. Notwithstanding the exemplary structures depicted in FIG. 1 and FIG. 2, it is understood that an electrophoresis chip provided herein optionally includes structures such as microchannels and microchambers that may or may not be interconnected with each another. An electrophoreis chip provided herein optionally includes a multitude of active or passive components such as microchannels, microvalves, micropumps, biosensors, ports, filters, fluidic interconnections, electrical interconnects, microelectrodes, and related control systems. Such components can be included in the chip itself or associated with the module, array or system in which an electrophoresis chip resides. Electrophoresis modules are discussed in detail below. Accordingly, the position and design of the structures depicted in FIG. 1 and FIG. 2 are not limited to the specific pattern exemplified in those figures.

During operation of the chip a voltage can be applied to the spatially defined electrophoretic matrix, of variable geometry, for the purpose of electrophoretic separation of analytes introduced into the matrix. The analytes are subsequently analyzed for molecules of interest. A variety of analytes can be separated on the basis of charge, including, but not limited to, biological molecules such as nucleic acids, proteins and carbohydrates or mixtures thereof.

Examples of materials suitable for use in forming an electrophoretic matrix include both gel-forming and non-gel forming polymers. Any gel matrix suitable for electrophoresis can be used for preparation of an electrophoretic matrix. Suitable matrices include acrylamide and agarose. It is recognized that other materials can be used as well. Additional examples include modified acrylamides and acrylate esters (for example see Polysciences, Inc. Polymer & Monomer catalog, 1996-1997, Warrington, Pa.), starch (Smithies, Biochem. J., 71:585 (1959); product number S5651, Sigma Chemical Co., St. Louis, Mo.), dextrans (for examples see Polysciences, Inc. Polymer & Monomer catalog, 1996-1997; Warrington, Pa.), and cellulose-based polymers (for example see Quesada, Current Opinion in Biotechnology,8:82-93 (1997)). Any of the polymers listed above is suitable for use as an electrophoretic matrix.

Composite matrices of polymers are also useful for forming the thin gels of the present invention. A composite matrix contains a mixture of two or more matrix forming materials, such as for example acrylamide-agarose composite gels. These gels typically contain 2-5% acrylamide and 0.5%-1% agarose. In these gels, the acrylamide concentration determines the functional pore size. Agarose provides mechanical strength without significantly altering the gel pore size of the acrylamide. The present inventions also envisions the use of borate buffer systems in conjunction with a chip, module, array or system. As used herein “matrix strengthening polymers” are polymers useful for cross-linking, stiffening, or otherwise modifying the gel matrix to make it more durable during handling, without adversely affecting the desired sieving properties of the resulting gel matrix. Matrix strengthening polymers toughen the gel matrix increasing its mechanical strength thus allowing it to be handled without additional external reinforcement. Exemplary polymers include agarose. In addition to strengthening the gel matrix, this polymer component may also provide additional sites for coupling gel modifying constituents. For example, chemical groups such as methyl or hydroxyl groups may be added to modify the hydrophobic/hydrophilic nature of the matrix. Sulfate or quaternary amine groups may be added to introduce ionic groups into the gel. Accordingly, a matrix as described herein includes a variety of established electrophoretic matrices. For example, use of ammonium persulfate activated tris-acrylamide gel matrix allowed to gel in the presence of a nitrogen atmosphere. Exemplary materials include agar, agarose, Acrylamide, Gelatin, Starch, Nitrocellulose, and defined Carbon:Carbon Lattices.

Referring again to FIG. 1, electrophoresis chip 100 is configured to include substrate 140 and electrophoretic pathway 130 configured to support the deposition of electrophoretic matrix 110. Examples of hydrophilic electrophoretic matrices include Agarose, various concentrations of Acrylamide:BisAcrylamide mixtures etc. As depicted in FIG. 1, electrophoretic pathway 130 can be any hydrophilic material that supports electrophoretic matrix 110 deposition. Such materials include polymers that possess carboxyl, hydroxyl, or amine, or a combination of functionalities, that allow electrophoretic pathway 130 to be a wetting surface. Optionally electrophoretic pathway 130 is treated with an agent that forms a covalent bond with electrophoretic matrix 110 subsequent to deposition. Such agents include Glass Bond™ or similar compositions. Addition of an appropriate volume of liquid (catalyzed) polymer to this prepared surface permits the gel to achieve a shape that is restricted to the hydrophilic region by a combination of surface tension and the covalent bond (e.g., see FIG. 1).

Substrate surface consisting of patterned hydrophobic and hydrophilic surfaces of various designs in order to accommodate a variety of applications, upon which, surface tension interactions create three dimensional fluid forms (e.g., “lanes”) that polymerize under appropriate conditions. The surface to be modified can be coated glass, plastic or other material as long as it is electrically inert and compatible with measurement of an appropriate signal generation reagent.

Referring to FIG. 2, the use of a hydrophobic electrophoretic matrix is also envisioned. Such a matrix would necessitate the use of a hydrophobic electrophoretic pathway and hydrophilic non-electrophoretic region. An example of a hydrophobic matrix includes Polyethyleneglycol methacrylate 200 in hydro-organic solvents.

Referring to FIG. 1 and FIG. 2, exemplary processes for fabricating electrophoresis chip 100 include microfabrication processes. The process of “microfabrication” as described herein relates to the process used for manufacture of micrometer sized features on a variety of substrates using standard microfabrication techniques as understood widely by those skilled in this art. The process of microfabrication typically involves a combination of processes such as photolithography, wet etching, dry etching, electroplating, laser ablation, chemical deposition, plasma deposition, surface modification, injection molding, hot embossing, thermoplastic fusion bonding, low temperature bonding using adhesives and other processes commonly used for manufacture of MEMS (microelectromechanical systems) or semiconductor devices.

Accordingly, the preparation of electrophoretic pathway 130 as depicted in FIG. 1 can be accomplished by a variety of means. One exemplary process includes laser etching a predetermined design on a coated surface, such as an Epoxy-Teflon coated surface. A second exemplary process includes the use lithographic methods to generate a mask. The mask is subsequently used to delineate areas of substrate 140 or non-electrophoretic region 120 such that appropriate photo-activated chemistries can be used to modify the surface so treated. In general, surface micro-machining builds structures on the surface of the silicon by depositing thin films of ‘sacrificial layers’ and ‘structural layers’ and by removing eventually the sacrificial layers to release the mechanical structures. The dimensions of these surface micro-machined devices can be several orders of magnitude smaller than bulk-micromachined devices. Additional methods known to the skilled artisan can be employed to create a design such that an electrophoretic matrix of essentially unlimited geometry in two dimensions can be formed on a surface.

The term “substrate” as used herein refers to the structural component used for fabrication of the micrometer sized features using microfabrication techniques. A wide variety of substrate materials are commonly used for microfabrication including, but not limited to; silicon, glass, polymers, plastics, ceramics to name a few. The substrate material may be transparent or opaque, dimensionally rigid, semi-rigid or flexible, as per the application they are used for. The terms “substrate” and “layer” are used interchangeably in this description.

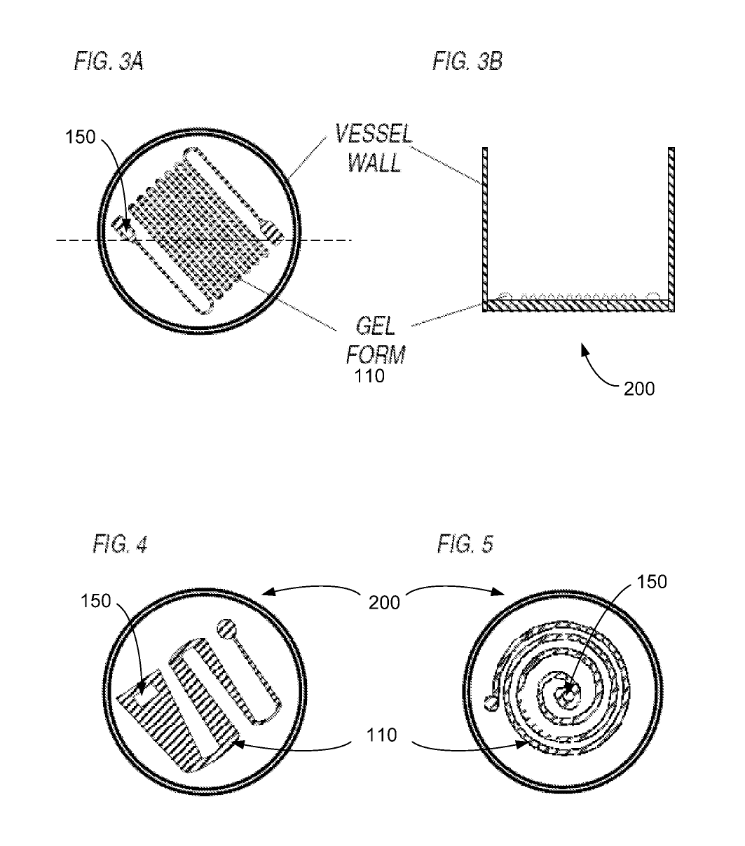

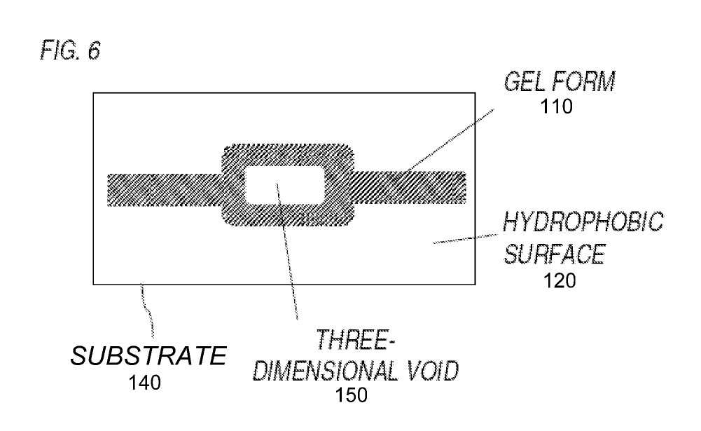

Referring to FIG. 3A, electrophoretic matrix 110 can include a reservoir 150 disposed to the proximal end of the flow path of the electrophoresis matrix. The reservoir can include a void region contained within the matrix. The proximal end of the matrix optionally includes a stacking matrix flowably connected with the flow path of the electrophoresis matrix. A further description of reservoir 150 is included in FIG. 6. It is understood that a void region can contain a sample in a horizontal, vertical or semi-vertical position. The surface tension associated with the small sample volume allows the sample to remain in the void in practically any position.

Referring to FIG. 3B, electrophoresis module 200 includes electrophoresis chip comprising electrophoresis matrix 110. The module includes a chamber and electrodes detachably connected to the chip for applying a voltage across the electrophoresis matrix suitable for the electrophoretic translocation of at least one analyte through the electrophoretic matrix. The placement of a matrix in a module allows the matrix to be treated with liquid reagents for the purposes of adding reagents (stains, nucleic acids, proteins, other affinity reagents, and buffers of various types). Module 200 is suitable for accommodating single or multi-step processes without physically disturbing or manipulating matrix 110. Thus, electrophoretic matrix forms prepared using this approach could can be monitored using a variety of methods, including fluorescent and non fluorescent measurements. It is also envisioned that the use of Flemings “Left Hand Rule” and a spiral design can be used to intentionally migrate molecules to the top or bottom surface of the gel form in conjunction with the separation to place the molecules into a common Z dimension, potentially facilitating analysis by an appropriate imaging system. Electrophoresis module 200 is discussed in greater detail further below.

Referring to FIG. 4 and FIG. 5, the configuration of electrophoretic matrix 110 associated with the electrophoresis chip includes linear, circular, coiled, curved, saw-toothed, or switchback, or any combination thereof. Any such configuration can further include reservoir 150. The flexible geometry property of the method of generating a matrix enables the use of linear tracks, tapered tracks, spirals, and other density maximizing designs to pursue micro electrophoresis. The use of “voids”, regions intentionally left hydrophobic, but contained within hydrophilic regions can be used to create 3-dimensional micro reservoirs for loading of sample, and/or buffers as needed to maintain sufficient hydration of the gel to permit electrophoresis (see e.g., FIG. 6).

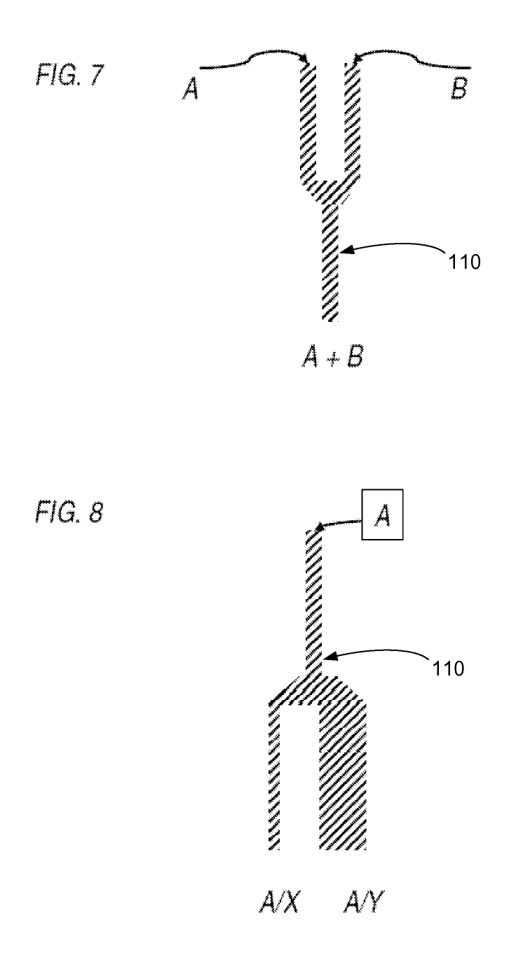

Referring to FIG. 7 and FIG. 8, also encompassed are matrix configurations that allow dispersion (e.g., FIG. 8) or collection (e.g., FIG. 7) of multiple materials into or from a common matrix 110. As material comprising analytes translocates from the cathode towards the anode the analytes can be parsed or commingled of in matrix 110.

Referring to FIG. 9, also encompassed are matrix 110 configurations that accommodate an additional discrete anode source. A voltage can be applied in a second direction at a time different than the initial direction, allowing in depth analysis of material that electrophoreses at a known rate or of suspected size in greater detail. Thus, the configuration of the electrophoretic matrix can include two or more flow paths converging in to a single flow path associated, for example, with the proximal end of the flow path.

Traditional electrophoresis is performed in an enclosed environment, and frequently materials that have been separated but are trapped within a gel matrix are either stained while in the gel or are transferred onto a membrane for further analysis by appropriate ancillary reagents, typically an affinity reagent complexed with a reporter system. Provided herein are chips, modules, arrays and systems that enable the creation of spatially defined conductive, yet unenclosed electrophoretic matrix, of variable geometry, for the purpose of electrophoretic separation of molecules.

As depicted in FIG. 3A, FIG. 4, and FIG. 5, provided herein are methods for manufacturing matrices of variable geometries. Such flexibility allows for run length maximizing layouts (e.g., density maximizing squiggs and spirals) far in excess of the linear distance across a surface. For electrophoretic separations, this is an attractive property, in that it allows for a large number of theoretical plates in a space constrained environment, thereby allowing higher resolution separations that would otherwise be impossible if a traditional linear approach were employed.

The incorporation of an electrophoresis matrix of complex geometry in a vessel allows for the matrix to be treated with reagents following a separation event. The resulting matrices can be probed individually using a wide variety of staining, labeling and reporting methods to generate signal to background measurements at a discrete location. Labels are discussed in detail below. However, it is understood that labels include any affinity reagent that is capable of entering the electrophoretic matrix for the purposes of specific identification of an analyte. Exemplary reagents include those derived from Nucleic Acids, Antibodies and fragments thereof, aptamers, haptens and synthetic affinity systems (tags).

In some aspects, a lower density matrix in combination with a resolving matrix can be employed in order to separate certain molecules, such as proteins, with the desired resolution. The incorporation of stacking gels into such as system is encompassed by the present invention. To achieve this, a stacking gel, and conduction gel system positioned perpendicular to the plane of resolution is envisioned. In addition to adding to the resolving power, this perpendicular construct can also be used to apply the power to the individual gel forms, and provide a reservoir of buffer/matrix that is capable of preventing a small exposed resolution gel form from drying out due to evaporation. Accordingly, “stacking gels & reservoirs” positioned such that the sample can be prepared/concentrated for higher resolution separation just prior to reaching the resolving gel form on the hydrophobic/hydrophilic surface, thereby improving the overall resolution of the system, are encompassed by the present invention. Various stacking gel systems are known to the skilled artisan and suitable for use in the present invention.

An exemplary stacking gel system is depicted in FIG. 9. The configuration depicted in FIG. 9 allows for electricity to be passed either via the stacking gel or directly into the gel form, such that a separation run may be used to create predefined size ranges of molecules for further electrophoretic separation in a different dimension. Y axis (see e.g., “1” in FIG. 9) can be, for example, sizing of the analytes in the matrix. The X axis (see e.g., “2” in FIG. 9) can, for example, be used for further sizing of the analytes into a different density matrix.

Assessment of analytes within the matrix form can be achieved using a wide variety of affinity reagents. For example, Flemings Left Hand Rule in a spiral configuration can be used to drive sample components in a 3rd dimension to facilitate contact with other surfaces and or devices. This can result in improved blotting or imaging by refining focal plane or by bringing in contact with a reporter surface (PCB) or affinity reagents.

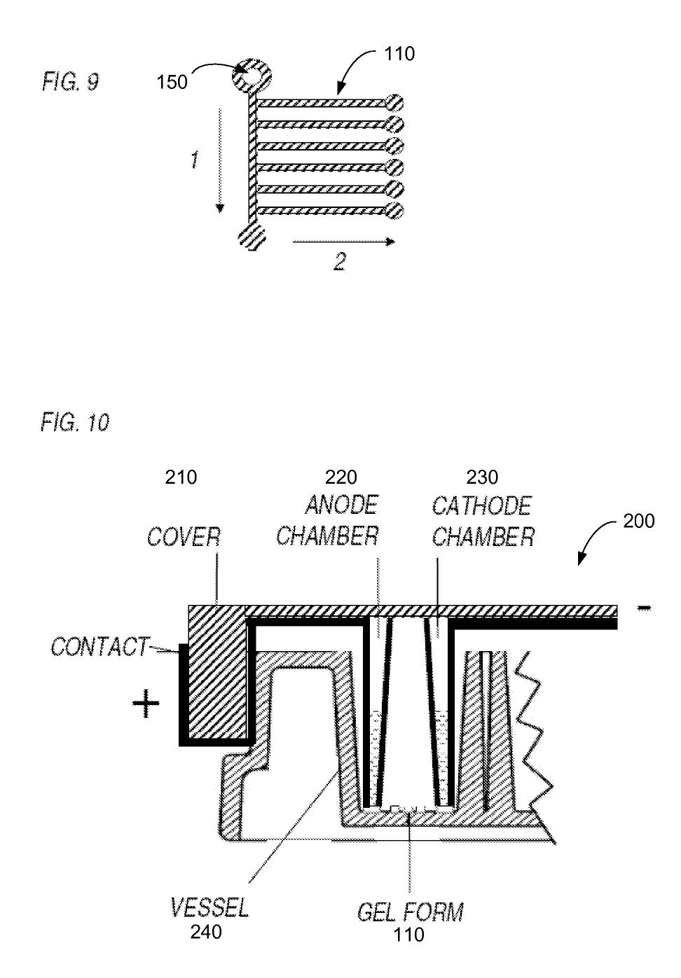

Referring generally to FIGS. 10, 11, 12 and 13, the electrophoretic modules, arrays and systems provided herein can generally be characterized as microfluidic devices. The term “microfluidic” generally refers to the use of enclosed microchannels for transport of liquids or gases. However, the electrophoretic chips, modules, arrays and systems provided herein encompass non-enclosed features for the transfer and/or separation of analytes in a matrix. Accordingly, the present inventions are distinguishable from previously described electrophoresis methods and apparatuses. It is further understood that, while providing non-enclosed features, the chips, modules, arrays or systems described herein can also include a multitude of microchannels forming a network and associated flow control components such as pumps, valves and filters. Microfluidic devices are ideally suited for controlling minute volume of liquids or gases. Typically, microfluidic devices can be designed to handle fluid volumes ranging from the picoliter to the milliliter range.

Referring to FIG. 10, electrophoresis module 200 includes electrophoresis matrix (e.g., gel form) 110 associated with vessel 240. Module 200 further includes at least one anode member 220 and one cathode member 230 functionally associated with matrix 110 such that a voltage can be applied across matrix 110. In addition, a module, described herein can include an applicator mechanism capable of applying a known amount of sample to a matrix. The applicator can also be used for the subsequent application of current to perform the electrophoresis. Referring to FIG. 10, anode member 220 and cathode member 230 can include chambers suitable for accommodating one or more capillaries capable of collecting a known volume of liquid in a chamber from a given sample in a vessel. Within the sample capillaries a material capable of conducting electricity is presented to apply suitable levels of current to the cathode, and collection at the anode after passing through the electrophoretic matrix. The design of this delivery system also serves as a reservoir for a stacking gel to increase resolution as needed.

Referring generally to FIG. 10, a matrix associated with a module can be monitored during, or subsequent to, a desired electrophoretic separation event. Accordingly, an electrophoresis module can be associated with one or more detectors for the detection and quantitation of an analyte. This arrangement provides considerable flexibility with regard to the nature of detection and does not limit the methods to the standard gel staining detection techniques common in traditional 2-D gel electrophoresis analysis. The detector can be adapted to resolve analytes within the matrix. The detection and quantitation of an analyte can be further enhanced by associating an analyte with a detectable label. Depending upon the particular label used, signal-to-noise ratios can be achieved which permit the detection of minute quantities of an analyte present in the matrix.

As used herein, the term “analyte” includes any molecule or compound that can be resolved by a gel matrix provided herein. Exemplary analytes include biological molecules such as proteins, nucleic acids, peptides, and organelles or cellular fractions. It should be noted that charged particles and materials of mineral and elemental forms can also be separated using electrophoresis.

In general, proteins can be detected utilizing a variety of methods. One approach is to detect proteins using a UV/VIS spectrometer to detect the natural absorbance by proteins at certain wavelengths (e.g., 214 or 280 nm). In other approaches, proteins in the various fractions can be covalently labeled through a variety of known methods with chromagenic, fluorophoric, or radioisotopic labels. A wide variety of chemical constituents can be used to attach suitable labels to proteins. Chemistries that react with the primary amino groups in proteins (including the N-terminus) include: aryl fluorides, sulfonyl chlorides, cyanates, isothiocyanates, immidoesters, N-hydroxysuccinimidyl esters, chlorocarbonates, carbonylazides, and aldehydes. Examples of chemical constituents that preferentially react with the carboxyl groups of proteins are benzyl halides and carbodiimide, particularly if stabilized using N-hydroxysuccinimide. Both of these carboxyl labeling approaches are expected to label carboxyl containing amino acid residues (e.g., aspartate and glutamate) along with that of the C-terminus. In addition, tyrosine residues can be selectively [¹²⁵I]-iodinated to allow radiochemical detection. Labeling can be performed at different points prior to detection.

Depending upon the composition of the protein-containing sample, labeling of proteins can affect the charge-to-mass ratio of the labeled proteins. For protein mixtures wherein the proteins have similar charge-to-mass ratios, the use of labels that preferentially react with particular residues can alter the charge-to-mass ratios sufficiently such that enhanced resolution is achieved. For example, a group of proteins can initially have a similar charge-to-mass ratio. However, if the proteins within the group are labeled with a neutral label that reacts primarily with lysine groups, proteins having a high number of lysine groups will bear more label and have a greater alteration in the charge-to-mass ratio than proteins having a lower number of lysine residues.

Additional means of detection include “electrophoretic tags (eTags).” eTags are small fluorescent molecules linked to an analyte, for example nucleic acids or antibodies. They are designed to bind one specific target analyte. After the eTag binds its target, a special proprietary enzyme cleaves the bound eTag from the target. The signal generated from the released eTag, called a “reporter,” is proportional to the amount of e.g. target messenger RNA or protein in the sample. The eTag reporters can be identified by electrophoresis methods and systems described herein. The unique charge-to-mass ratio of each eTag reporter provides for a specific peak on the electrophoresis readout.

A variety of labels that preferentially react with specific residues are available for use. The reactive functionality on the label is selected to ensure labeling of most or all of the components of interest. For example, sulfophenylisothiocyanate can be used to selectively label lysine residues, altering their charge from positive (below a pH of 10) to negative (above a pH of 0.5). Similarly, phenylisothiocyanate can be used to neutralize the lysine and N-terminal positive charges at all pH. Dansyl chloride can be used to lower the pH at which lysine and N-terminal residues carry a net positive charge. The addition-of amino functional alkyl ammonium salts to aspartic and glutamic acid residues, such as through carbodiimide coupling, alters their charge from negative to positive at low pH.

In general the label should not interfere with fractionation during electrophoresis and should emit a strong signal so that even low abundance proteins can be detected. The label preferably also permits facile attachment to proteins. Suitable labels include, for example, radiolabels, chromophores, fluorophores, electron dense agents, NMR spin labels, a chemical tag suitable for detection in a mass spectrometer, or agents detectable by infrared spectroscopy or NMR spectroscopy for example. Radiolabels, particularly for spatially resolved proteins, can be detected using phosphor imagers and photochemical techniques.

Certain methods utilize fluorophores since various commercial detectors for detecting fluorescence from labeled proteins are available. A variety of fluorescent molecules can be used as labels including, for example, fluorescein and fluorescein derivatives, rhodamine and rhodamine derivatives, naphythylamine and naphythylamine derivatives, benzamidizoles, ethidiums, propidiums, anthracyclines, mithramycins, acridines, actinomycins, merocyanines, cyanines, coumarins, pyrenes, chrysenes, stilbenes, anthracenes, naphthalenes, salicyclic acids, oxazine, benz-2-oxa-1-diazoles (also called benzofurazans), fluorescamines, Alexa and bodipy dyes.

In some instances, the proteins separated by the methods of the invention are subjected to further analysis by mass spectroscopy. In such instances, particular labels can be utilized to enhance separation of mass fragments into certain parts of the mass spectrum. Quantitation of detected signals can be performed according to established methods. Peak height and peak area are typically used to quantify the amount of each resolved protein in the final electrophoretic dimension. In some methods, the peak height, peak width at the half height, peak area, and elution time for each peak are recorded. Peak shape (determined as the height to width ratio) can be used as a measure of the quality of the separation method. The resolution potential of the method can be determined by correlating the MW of the protein with the elution time.

The present invention is well-suited for use with systems that utilize a scanning laser, precision optics, and filters to direct fluorescent emissions from a microplate onto multiple photomultiplier tube (PMT) detectors. An example of such a system is the Acumen Explorer® system which uses lasers to scan, for example, multiple chips. The Acumen laser samples the well at regular intervals and thresholding algorithms identify all fluorescent intensities above the solution background without the need to generate and analyse an image.

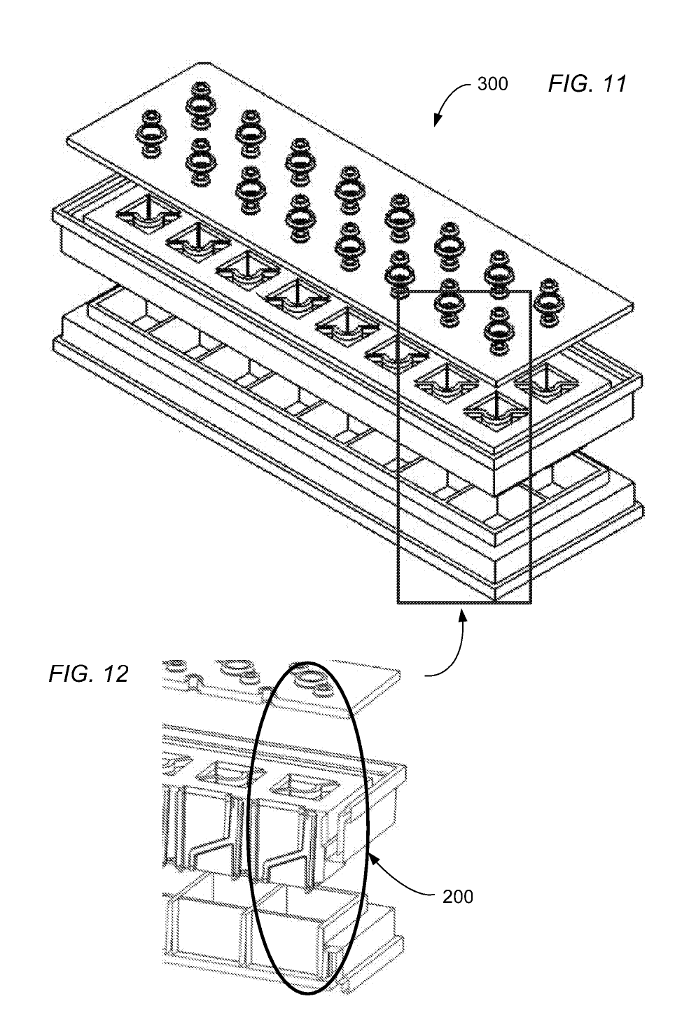

In another embodiment, an array of modules is provided herein. Referring to FIG. 11, electrophoresis array 300 includes multiple electrophoresis modules 200 (see FIG. 12). Electrophoresis array 300 can be configured in the same manner as, for example, a micro-titer plate. Such an array provides parallel processing of multiple samples. An electrophoresis system provided herein is compatible with standard laboratory automation approaches employed in the life science and clinical diagnostics environments.

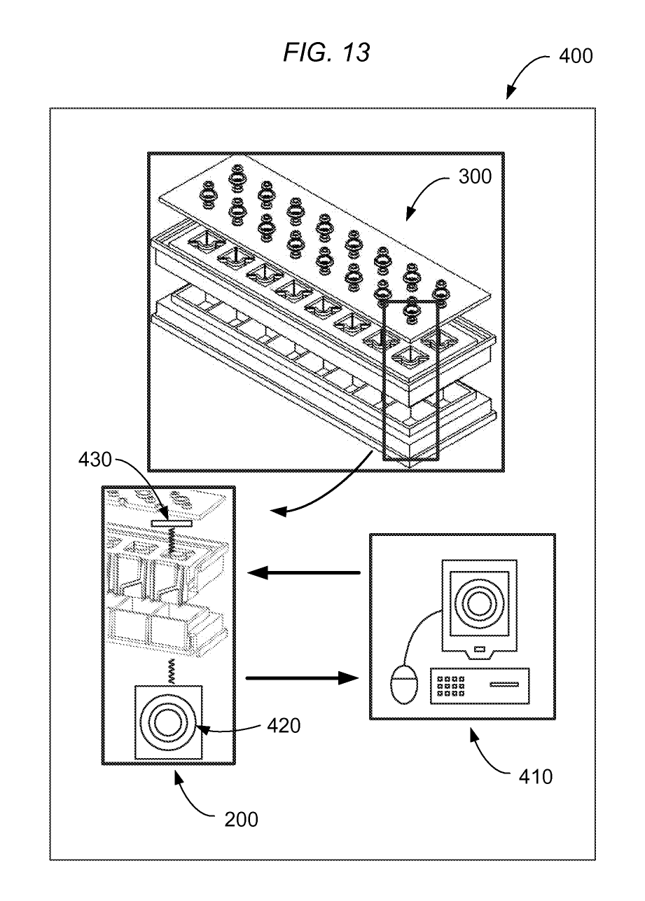

The various embodiments described above include electrophoresis chips, electrophoresis modules that incorporate at least one electrophoresis chip, and electrophoresis arrays that incorporate multiple modules. In another embodiment, electrophoresis systems are also provided. Referring to FIG. 13, a schematic diagram of an electrophoresis system 400 adapted to include electrophoresis array 300 or module 200, is depicted. System 400 is configured to measure the analytes present in modules. System 400 may include a mount for positioning array 300 or module 200 relative to detector assembly 420. Radiation source 430 can be associated with each module 200 or a single radiation source can be used to illuminate a plurality of modules in an array. System 400 includes a detector assembly 420, and a controller 410 for storing representations detected by detector assembly 420 and for controlling other aspects of system 400 function. For example, a single controller 410 can perform both control and measurement functions. Optionally, controller 410 is adapted to measure the progress of a separation event in each module and to integrate the information with the voltage applied to each module. Accordingly, controller 410 can be adapted to synchronize the capture the representation of a specific analyte at a specific point in a separation event. During operation of system 400, the number of continuous measurements is limited only by the amount of storage available to store the information generated by the system. Controller 410 can further optionally include algorithm(s) for analyzing the representations stored by storage device, and provides a user with information about specific analytes based on the analysis of, for example, their position in a matrix at a given point in time.

It is understood that detector assembly 420 can be adapted to include any mechanism suitable for detecting analytes in a matrix as generated by a system provided herein. Throughout the present disclosure the capture of “representations” associated with an electrophoresis matrix are described. For example, a “representation” of an analyte is any form of information generated by the detection of the analyte. The information can be in the form of, for example, an image detected by the emission of photons from the analyte. Alternatively, the information can be in the form of digital information generated from a laser scan of the electrophoresis matrix. Accordingly, any means of detecting an analyte present in a matrix is encompassed by the present invention. Such detection includes, but is not limited to, amplitude, frequency/wavelength and phase, lifetime, polarity, anisotropy (i.e. covering reflectance, fluorescence and colorimetric/absorbent approaches), electrical charge & impedance (when the hydrophilic/phobic surface has an embedded charge differential sensing region), radioactivity. Components of the system will vary as a function of detection methodologies pursued. For light and fluorescence based systems a light source, interacts with a stain/label or reporter system and reporter connected to one or more light collection devices. Note that wavelength specific light refraction systems and plasmon resonance systems might also be applicable to such a system for “reporter or label free” measurements.

In exemplary embodiments discussed above, the detector assembly is a CMOS (complementary metal oxide semiconductor) imager. As used herein, CMOS refers to both a particular style of digital circuitry design, and the family of processes used to implement that circuitry on integrated circuits. Accordingly, a CMOS imager may include a chip with a large number of CMOS transistors packed tightly together (i.e., a “Complementary High-density metal-oxide-semiconductor” or “CHMOS”). Alternatively, or additionally, a CMOS imager may include a combination of MEMS sensors with digital signal processing on one single CMOS chip (i.e., a “CMOSens”). Additional detectors include, for example, an array of charge coupled devices (“CCDs”), a camera with photosensitive film, a photodiode, or a Vidicon camera.

In any of the embodiments described above, controller 410 can be a computer that includes hardware, software, or a combination of both to control the other components of the system and to analyze matrix representations to extract the desired information about analytes therein. The analysis described above can be implemented in computer programs using standard programming techniques. Such programs are designed to execute on programmable computers each comprising a processor, a data storage system (including memory and/or storage elements), at least one input device, at least one output device, such as a display or printer. The program code is applied to input data to perform the functions described herein and generate information which is applied to one or more output devices. Each computer program can be implemented in a high-level procedural or object-oriented programming language, or an assembly or machine language. Each such computer program can be stored on a computer readable storage medium (e.g., CD ROM or magnetic diskette) that when read by a computer can cause the processor in the computer to perform the analysis described herein. Such analysis can include multiplexed detection of multiple affinity reagents. These data can be generated by measuring ratio's of condition (A:B) at a similar size or a series of reagents to detect a multiplicity of proteins of different sizes, or a combination thereof. From a detection perspective, this provides for X specific size reagents and Y specific reporter channels so long as the reporter channels are resolved from each other.

It is understood that system includes a high voltage power supply with either a single or fully independently controlled delivery of current to/from a single module or a series of modules (e.g., an array) simultaneously. Each module includes a single cathode/anode or a series of cathodes/anodes as a function of the design of the matrix. The modules have power applied in a measured way to ensure comparable results from module to module. The present modules, arrays and systems encompass the use of pulsed field electrophoresis.

Immediately after the required separation of analytes is achieved, the high voltage power is turned off. At this step in the process it is preferable to secure or “fix” the analytes to prevent the loss of analyte during any incubation with labels and reporter molecules during washing steps. Accordingly, system 400 optionally includes a radiation source for the photoactivation of cross linkers optionally added to the matrix. While such a radiation source is generally ultaviolet light, the present invention encompasses the use of other radiation sources and cross linking reagents. It is also possible that an alcohol or acid treatment be used to fix the proteins to the gel form matrix, and this would eliminate the need for the radiation source. It is understood that the radiation source can be different for “fixing” purposes than for “detecting” purposes. Alternatively, the same radiation source can be used to achieve both fixation and detection.

Following labeling/staining, for detection of the signals from the stained labels, there are several options. In the case of radiation-based systems, excitation radiation source(s) can be either mono or polychromatic light, and can be either scanned across a single or a series of cells illuminated in a bright field, or confocal approach. For detection, a photomultiplier tube, photodiode or other photon sensing array, including CCD or other cameras can be placed to collect emitted photons, with filters applied as needed to create discrete channels for fluorescent or calorimetric light in the case of the photomultiplier tube or several captures (exposures) that can be overlayed in the case of the camera.

It is understood that a system provided herein can further include devices for high volume applications such as a plate loader device, an assembly opener, and robotics liquid handling systems, and an appropriate scanner or imager could be arranged in a sequence. Currently available bio-imager systems could be used to generate representations of the processed plate with software used to reduce the representations to images making the data appear more conventional, and or take appropriate measurements to quantitate the relative abundance of signals.

Provided herein are devices and methods useful for the separation of molecules on the basis of electrophoretic mobility and identification of molecules for the purpose of measurement, quantitation and detection of biomolecules. The micro electrophoresis methods and devices provided herein can be used in fields such as clinical diagnostics for HIV confirmation, Lyme disease, toxoplasmosis, syphillis confirmation etc. Industrial diagnostic include detection of BSE and other routine herd management screens for food supply assurance.

The examples set forth above are provided to give those of ordinary skill in the art a complete disclosure and description of how to make and use the embodiments of the devices, systems and methods of the invention, and are not intended to limit the scope of what the inventors regard as their invention. Modifications of the above-described modes for carrying out the invention that are obvious to persons of skill in the art are intended to be within the scope of the following claims. All patents and publications mentioned in the specification are indicative of the levels of skill of those skilled in the art to which the invention pertains. All references cited in this disclosure are incorporated by reference to the same extent as if each reference had been incorporated by reference in its entirety individually.

A number of embodiments of the invention have been described. Nevertheless, it will be understood that various modifications may be made without departing from the spirit and scope of the invention. Accordingly, other embodiments are within the scope of the following claims.

What is claimed is:

1. An electrophoresis chip comprising:
a) a substrate comprising at least one surface suitable for supporting structures in and/or on the substrate;
b) an electrophoretic pathway associated with the surface and configured to support the deposition of an electrophoretic matrix;
c) a non-electrophoretic region associated with the surface and adjacent to the electrophoretic pathway, wherein the region does not support the deposition of an electrophoretic matrix; and
d) an electrophoretic matrix associated with the electrophoretic pathway, wherein the matrix is:
1) elevated in relation to, and structurally independent of, the adjacent region; and
2) spatially configured to support a flow path for the electrophoretic translocation of at least one analyte, wherein the flow path comprises a proximal end for analyte in flow and a distal end.

2. The electrophoresis chip of claim 1, wherein the substrate is comprised of silicon, glass, polymers, plastics, ceramics, or some combination thereof.

3. The electrophoresis chip of claim 1, wherein the electrophoretic pathway is comprised of hydrophilic material.

4. The electrophoresis chip of claim 3, wherein the hydrophilic material comprises a polymer that possess carboxyl, hydroxyl, or amine functionalities.

5. The electrophoresis chip of claim 1, wherein the non-electrophoretic region is comprised of hydrophobic material.

6. The electrophoresis chip of claim 5, wherein the hydrophobic material is selected from the group consisting of fluorocarbon polymers, silanes, silicones, methane-plasma treated surfaces, and tert-butyl modified surfaces.

7. The electrophoresis chip of claim 1, wherein the electrophoretic matrix is comprised of hydrophilic material.

8. The electrophoresis chip of claim 7, wherein the hydrophilic material is selected from the group consisting of agarose, acrylamide:bisAcrylamide, chemically modified acrylamides, starch, dextrans, cellulose-based polymers, and acrylate esters.

9. The electrophoresis chip of claim 1, wherein the electrophoretic matrix is covalently associated with the electrophoretic pathway.

10. The electrophoresis chip of claim 1, wherein the analyte is a biomolecule.

11. The electrophoresis chip of claim 1, wherein the configuration of the electrophoretic matrix is linear, circular, coiled, curved, saw-toothed, or switchback, or any combination thereof.

12. The electrophoresis chip of claim 1, wherein the configuration of the electrophoretic matrix comprises two or more flow paths converging in to a single flow path.

13. The electrophoresis chip of claim 12, wherein the single flow path is associated with the proximal end of the flow path.

14. The electrophoresis chip of claim 1 further comprising a reservoir disposed to the proximal end of the flow path of the electrophoresis matrix, wherein the reservoir comprises a void region contained within the matrix.

15. The electrophoresis chip of claim 14, wherein the reservoir is a hydrophobic void region.

16. The electrophoresis chip of claim 1 further including a stacking matrix flowably connected with the proximal end of the flow path of the electrophoresis matrix.

17. The electrophoresis chip of claim 16 further comprising a reservoir disposed to the stacking matrix, wherein the reservoir is a hydrophobic void region.

18. The electrophoresis chip of claim 14 or 17, wherein the reservoir is configured to contain:
a) a sample comprising an analyte;
b) a buffer solution; or
c) a combination of a) and b).

19. The electrophoresis chip of claim 1 further comprising electrodes operably associated with the electrophoresis matrix.

20. An electrophoresis module comprising:
a) an electrophoresis chip according to claim 1;
b) a chamber comprising the chip according to a); and
c) electrodes operably associated with the chip for applying a voltage across the electrophoresis matrix suitable for the electrophoretic translocation of at least one analyte through the electrophoretic matrix.

21. The electrophoresis module of claim 20, wherein the electrodes comprise an anode operably associated with the proximal end of the electrophoresis matrix and a cathode operably associated with the distal end of the electrophoresis matrix.

22. An electrophoresis array comprising a plurality of electrophoresis modules according to claim 20.

23. A system comprising:
a) an electrophoresis module according to claim 20 or array according to claim 22;
b) a plurality of fluid communication ports located around a periphery of the module or array;
c) a radiation source associated with each module or module of the array and configured to illuminate the electrophoresis matrix, wherein the radiation source is suitable for generating detectable representations of analytes;
d) a detector assembly configured to capture the representations associated with each electrophoresis matrix; and
e) a controller operably associated with the system and configured to:
1) synchronize the voltage input from a power source with the configuration of each electrophoresis matrix; and
2) electronically record and/or display the representations captured by the detector.

24. The system of claim 23, wherein the electrophoretic matrix is detectably labeled during or subsequent to application of the voltage.

25. The system of claim 23, wherein the radiation source comprises at least one excitation light source.

26. The system of claim 25, wherein the excitation light source is mono or polychromatic.

27. The system of claim 23, wherein the controller is further configured to synchronize representation detection by detector with the voltage input from a power source.

28. The system of claim 23, wherein the detector assembly comprises at least one photomultiplier tube, complementary metal oxide semiconductor (CMOS) imager, a charge coupled device (CCD) imager, a camera with photosensitive film, a photodiode, a Vidicon camera, or any combination thereof, for detection of the representation.

29. The system of claim 28, wherein the detector assembly further comprises filters to create discrete channels for fluorescent or calorimetric light.

30. An electrophoresis chip comprising:
a) a substrate comprising at least one surface suitable for supporting structures in and/or on the substrate;
b) a guide pathway associated with the surface and configured to direct the deposition of an electrophoretic matrix;
c) a non-electrophoretic region associated with the surface and adjacent to the electrophoretic pathway, wherein the region does not support the deposition of an electrophoretic matrix; and
d) an electrophoretic matrix associated with the guide pathway, wherein the matrix is:
1) confined to guide pathway and structurally independent of the guide pathway on at least one side; and
2) spatially configured to support a flow path for the electrophoretic translocation of at least one analyte, wherein the flow path comprises a proximal end for analyte in flow and a distal end.

31. The electrophoresis chip of claim 30, wherein the guide pathway comprises a channel that facilitates the deposition of the matrix.
